(19) United States
(12) Patent Application Publication
(10) Pub. No.: US 2015/0228219 A1
(43) Pub. Date: Aug. 13, 2015

(54) Dual Modulator Synchronization in a High Dynamic Range Display System

(71) Applicant: Dolby Laboratories Licensing Corporation, San Francisco, CA (US)

(72) Inventors: Noam Noiman, Foster City, CA (US); Matthew Peter Robinson, San Anselmo, CA (US); Christopher Orlick, Washington Crossing, PA (US)

(73) Assignee: Dolby Laboratories Licensing Corporation, San Francisco, CA (US)

(21) Appl. No.: 14/179,409

(22) Filed: Feb. 12, 2014

(51) Int. Cl. G09G 3/32; G09G 3/34

(52) U.S. Cl. CPC G09G 3/32; G09G 3/3406; G09G 2310/08; G09G 2320/0693

(57) ABSTRACT

A dual and/or multi modulator display system is disclosed comprising at least a first modulator and a second modulator wherein one of modulators has a faster response time that the other modulator. The response of the slower modulator may be characterized according to various image data inputs and this characterized data may then be used by the display system to derive control and/or data signals to the faster modulator. These control/data signals may represent a fitted set of data matched to one or more characteristics of the slower modulator in order to reduce light produced during frame or other transition times of the modulators. One or more characteristics may be employed to reduce such undesirable visual effects.

### TECHNICAL FIELD

The present invention relates to displays systems and, more particularly, to display systems having Enhanced Dynamic Range (EDR) capability.

### BACKGROUND

In a dual and/or multi-modulator display system, it may be the case that one modulator may be refreshed with image and/or control data from a controller at a faster rate than another modulator with the same display system. When this occurs, it is possible to have undesirable visual artifacts. One conventional display system may comprise two modulators: (1) an array of Light Emitting Diodes (LEDs) that provide a locally dimmable backlight that illuminates (2) a Liquid Crystal Display (LCD) that further modulates the light to produce the final viewable image.

One prior art reference describes the visual artifact and the desirability of eliminating and/or mitigating such artifacts: United States Patent Application Publication No. 2010/0295879 to Tanaka et al., published on Nov. 25, 2010 and entitled “IMAGE DISPLAY APPARTUS”—which is hereby incorporated by reference.

### SUMMARY

Several embodiments of display systems and methods of their manufacture and use are herein disclosed. A dual and/or multi modulator display systems is disclosed comprising at least a first modulator and a second modulator wherein one of modulators has a faster response time that the other modulator. The response of the slower modulator may be characterized according to various image data inputs and this characterized data may then be used by the display system to derive control and/or data signals to the faster modulator. These control/data signals may represent a fitted set of data matched to one or more characteristics of the slower modulator in order to reduce light produced during frame or other transition times of the modulators. One or more characteristics may be employed to reduce such undesirable visual effects.

In one embodiment, a display system is disclosed comprising: a light source, said light source comprising an array of LED backlights; an LCD modulator, said LCD modulator illuminated by said light source and modulating said light source to render an image; a controller, said controller further comprising: a processor; a memory, said memory associated with said processor and said memory further comprising processor-readable instructions, such that when said processor reads the processor-readable instructions, causes the processor to perform the following instructions: receiving image data, said image data to be rendered by said display system; receiving LCD characterization data, said LCD characterization data based upon a characterization of the one or more LCD behaviors; deriving LED control signals, said LED control signals providing a fitted LED response based upon one or more LCD behaviors; and sending LED control signals to said light source and control signals to said LCD to form the desired screen image.

In another embodiment, a method for providing LED signals to match LCD characteristics is provided, said method comprising: receiving input image data to be rendered on a display system, said display system further comprising an array of LED backlights illuminating an LCD modulator; receiving data characterizing the raster scanning of the LCD; calculating timing offsets to be applied to control signals to LEDs in proximity to the LCD pixels such that the LED illumination matches the raster scanning of LCD; and sending the LED control signals to the LEDs.

Other features and advantages of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is one embodiment of a dual modulator display system comprising a backlight array of LEDs and a LCD modulator to form the final viewing image that may be suitable for the systems, methods and techniques of the present application disclosed herein.

FIGS. 2A and 2B depict the situation when the LED backlight and the LCD modulator are transitioning in the same direction and opposite directions, respectively.

FIGS. 3 through 6 depict embodiments employing the vertical phasing of LED in response to the LCD raster scan to reduce undesired visual artifacts.

FIGS. 7A through 7H depict the characterization of the LCD response and the application of an offset time to the LED control signals to reduce undesired visual effects.

FIG. 8 depicts the Area Under the Curve response versus the offset times.

FIGS. 9A and 9B depict LED and LCD responses when transitions in opposite directions and the AUC response respectively.

FIGS. 10A and 10B depict LCD response curves of several LCDs to Opening and Closing control signals respectively.

FIGS. 11A through 11H depict the combined effects of LED slewing with various offsets and their AUC response respectively.

FIG. 12 shows the combined graph of the AUC responses to FIGS. 11A through 11H.

FIG. 13 shows comparative results between LED vertical phasing alone and LED vertical phasing combined with LED slewing at various time offsets.

FIG. 14 is one embodiment of a system/method that combines one or more of the various techniques described herein.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As utilized herein, terms “component,” “system,” “interface,” “controller” and the like are intended to refer to a computer-related entity, either hardware, software (e.g., in execution), and/or firmware. For example, any of these terms can be a process running on a processor, a processor, an object, an executable, a program, and/or a computer. By way of illustration, both an application running on a server and the server can be a component and/or controller. One or more components/controllers can reside within a process and a component/controller can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Dual/Multi-Modulator EDR Display System Embodiments

EDR display systems comprising dual/multi-modulators have been described in commonly-owned patents and patent applications, including:

(1) United States Patent Application Publication US 2010/0277515 to Ward et al., published on Nov. 4, 2010 and entitled “MITIGATION OF LCD FLARE”;

(2) United States Patent Application 20100328537 to Davies et al., published on Dec. 30, 2010 and entitled “SYSTEM AND METHOD FOR BACKLIGHT AND LCD ADJUSTMENT”;

(3) United States Patent Application 20120075360 to Messmer, published on Mar. 29, 2012 and entitled “SYSTEMS AND METHODS FOR CONTROLLING DRIVE SIGNALS IN SPATIAL LIGHT MODULATOR DISPLAYS”;

(4) United States Patent Application 20110193895 to Johnson et al., published on Aug. 11, 2011 and entitled “HIGH DYNAMIC RANGE DISPLAY WITH REAR MODULATOR CONTROL”; and

(5) United States Patent Application 20090322800 to Atkins, published on Dec. 31, 2009 and entitled “METHOD AND APPARATUS IN VARIOUS EMBODIMENTS FOR HDR IMPLEMENTATION IN DISPLAY DEVICES”.

which are hereby incorporated by reference in their entirety.

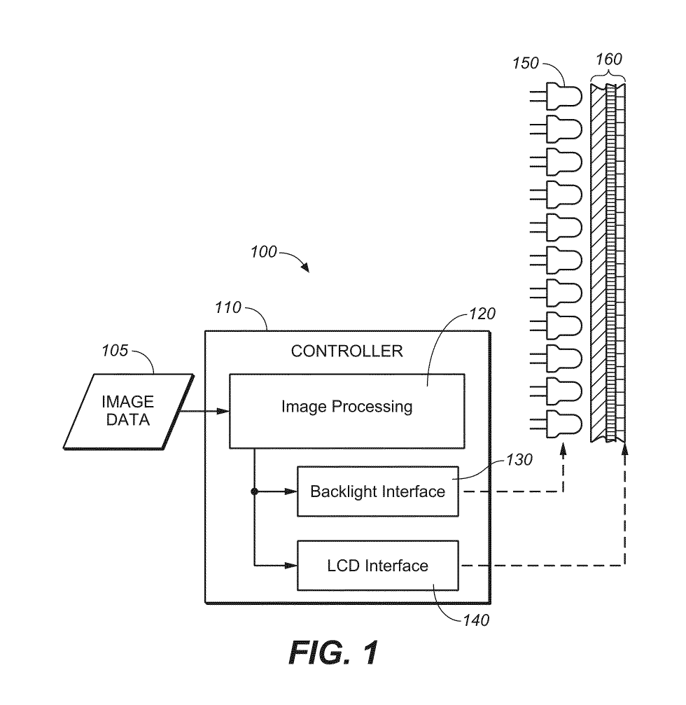

FIG. 1 depicts one exemplary embodiment of an EDR display system 100 comprising an array of LEDs forming a backlight 150 (as a first modulator) and a LCD panel 160 (as a second modulator of the display system). As may be seen, image data 105 may be received by a controller 110. Controller may provide image processing 120 to create control signals for the LEDs and the LCD via a suitable backlight interface 130 and an LCD interface 140.

It will be appreciated that FIG. 1 is merely one exemplary embodiment of a dual modulation system consisting of modulators with differing transition times that may be subject to visual artifacts. It should also be appreciated that the systems, methods and/or techniques of the present application may be applicable to other display systems that may have such a mismatch in their transition times as by and between the various modulator stages. For example, projector systems may exhibit these timing mismatch artifacts between a MEMS array and a LCD at two possible modulators in a multi-modulator projector system.

Staying with the embodiments involving an LED backlight disposed behind an LCD, there is likely a significant difference in response times, with the LED being orders of magnitude quicker than the LCD. Given the more rapid response time of the LEDs, there may be an opportunity to modulate one modulator advantageously with respect to the other modulator to reduce and/or mitigate any visual artifact.

In one embodiment, it may be possible to modulate the LEDs such that the LEDs may be slowly transitioned through intermediate states to better match the response and alignment of the LCD. In this way, the displayed light at a pixel (which is the product of the LED and LCD transmittance) may be substantially constant throughout the LCD transition. As LEDs have very high speed drive signals, this embodiment represents one possible option.

In another embodiment, there may be an alternative option to affect in order to minimize undesirable visual artifacts. This alternative employs another imbalance that tends to exist in LED/LCD dual modulation displays. That is that the number of individually addressable LCD elements tends to be many orders of magnitude higher than the number of LED elements. As a result, each LED creates a backlight that passes through hundreds or thousands of LCD elements.

Thus, as a practical matter, it may be difficult to directly determine any given transition (e.g., skewed transition or the like) of the LEDs between states, as there are thousands of possible LCD responses to match. It may be possible to affect an analysis of typical LCD transition curves (along with a focus on correcting the most visually harmful artifacts) that may yield transition curves that may improve the visual performance of these systems—despite the daunting numbers of potentially unique LCD transitions near each LED. In fact, it may be possible that the actual LCD starting and ending transmittances need not be known in determining the best LED slew transition, thus, creating a simplified real time solution.

Examples of Visual Artifact Introduction

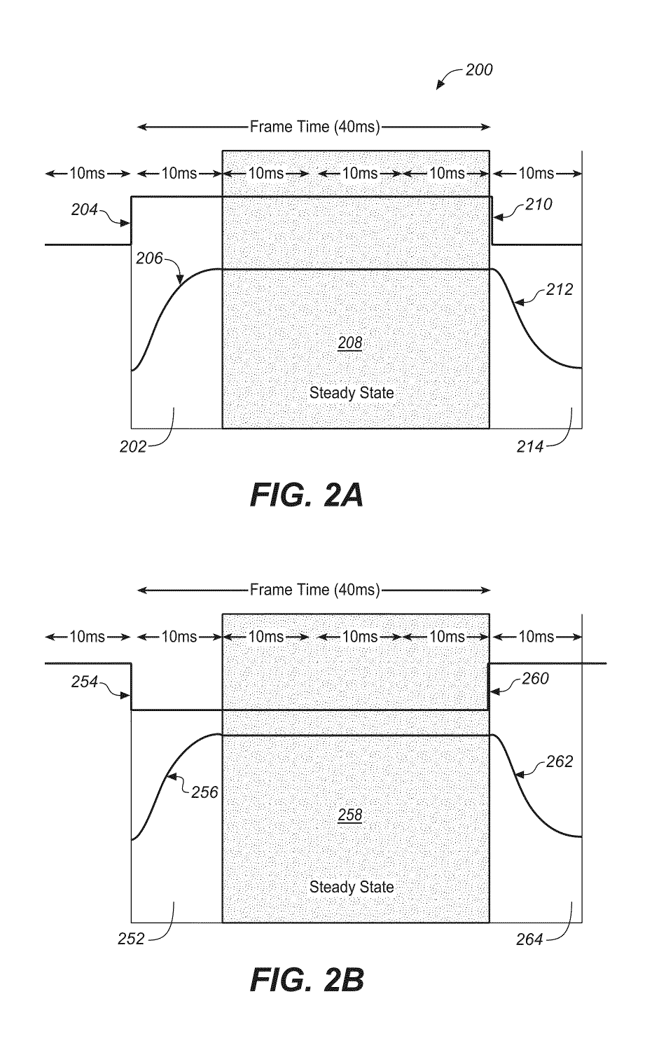

To better understand the undesirable visual artifacts that may arise during the course of displaying images with this display system, FIGS. 2A and 2B depict exemplary transitions of the LED backlight and the LCD transmittance as the LEDs and LCD move in same (e.g. ON/open) direction and opposite (e.g. OFF/open) directions, respectively.

In FIG. 2A, it may be seen that the LCD is transitioning from a Closed-to-Open transmittance at 206—while at the same time, the LEDs are transitioning from Off-to-On at 204. As the time for transition is essentially instantaneous (as compared with the LCD transition time), there is a period of time (at 202) in which there is a possibility of a noticeable and undesirable visual artifact.

Once the LCD has ramped up to its desired level for a given frame, then the illumination through the LCD pixel enters a steady state at 208. At the end of this frame period, the controller may order the LED backlight OFF at 210 and the LCD to reduce its transmittance (through curve 212). Again, there is a period 214 during which the mismatch in transition speed of the LEDs and the LCD may give rise to an undesirable visual artifact.

In FIG. 2B, a very similar scenario may play out in the case where the LED is transitioning from ON-to-Off at 254, the LCD transitioning over curve 256—giving an undesirable opportunity at 252. After a period of steady state 258, the LED may be controlled to the ON state at 260, the LCD transitioning over curve 262—giving an undesirable opportunity at 264.

Embodiments Involving Vertical Phasing

One technique for addressing the transition time mismatch between a first modulator and a second modulator—e.g., such as in a LED/LCD display system or a LCD/MEMS projector system—may involving a proper phasing of the data/control signals between the two modulators.

To better understand this technique, it should be appreciated that many of today's LCD technologies use a raster scan to update the display. This is typically done in a vertically descending region order. The time it takes to update the entire raster is directly related to the LCD's refresh rate. For example, a LCD driven at a refresh rate of 100 Hz takes approximately 10 ms to scan the raster. Let f_{LCD} be the LCD's refresh rate. If a LCD is divided into N vertical regions, then the n^{th} ε[1, N] vertical region starts updating after

$$\frac{n - 1}{N * {f}_{LCD}}$$

seconds.

This behavior may be leveraged to good advantage in this embodiment—while the LCD updates as described, the LED back light display may be changed along a different, desired time interval. In fact, when using LED elements to construct a backlight, the typical time interval to change between one value to another can be as short as tens to hundreds of μs. As mentioned, this temporal mismatch between the two modulators may cause an objectionable visual artifact such as a flash during a transition in the source signal.

For merely one example, without a proper synchronization of the two modulators, there may be one arbitrary region that is “optimal” in terms of synchronization. In this case, artifacts may be minimal around this “optimal” region; however, as considering the displayed image moving vertically further (in both directions) away from this region, the output may tend to become increasingly un-synchronized. The outcome of this behavior under certain input signal patterns may yield a non-uniform flashing output signal which is more objectionable to the human eye.

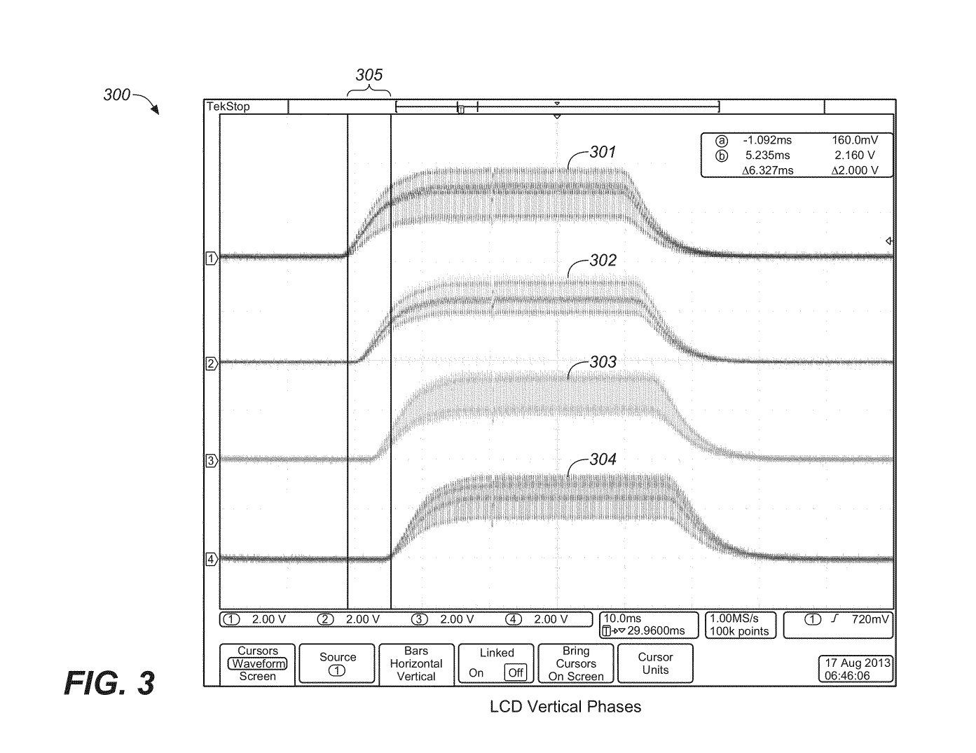

FIGS. 3 through 6 depict embodiments of systems, methods and/or techniques to eliminate and/or mitigate these visual artifacts, as made in accordance with the principles of this present application. As may be seen, FIG. 3 depicts the vertical phasing 300 that may occur over the entire LCD—as the data/control signals from the controller may be scanned and/or rastered over the LCD (e.g., possibly in a row-by-row fashion). As may be also seen, the control signals for region 1 (301) may start during a time period 305. A short time later, control signals for region 2 (302) may commence—and so on, for signals 303 and 304 for region 3 and 4, respectively. A region may be a row or it may be another suitable area of the backlight.

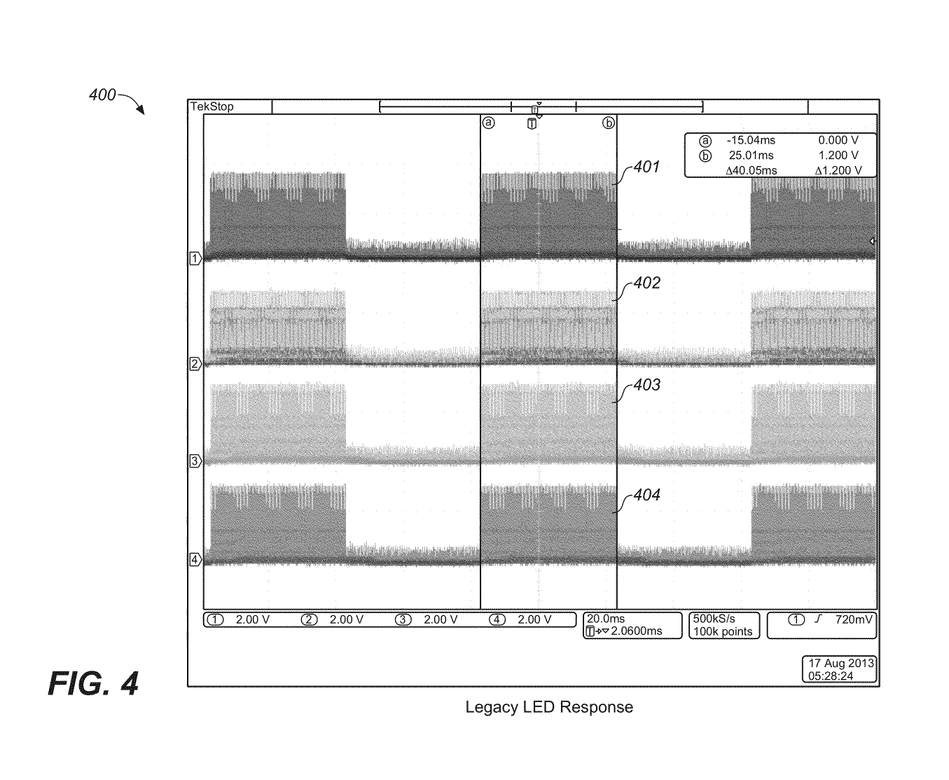

In the case of the LCD being paired with a faster modulator (e.g., LEDs, MEMS and the like), FIG. 4 represents the response time of the faster modulator—with the substantially instantaneous response curves 401, 402, 403 and 404 which may be applied at near same time to the different region of the LCD.

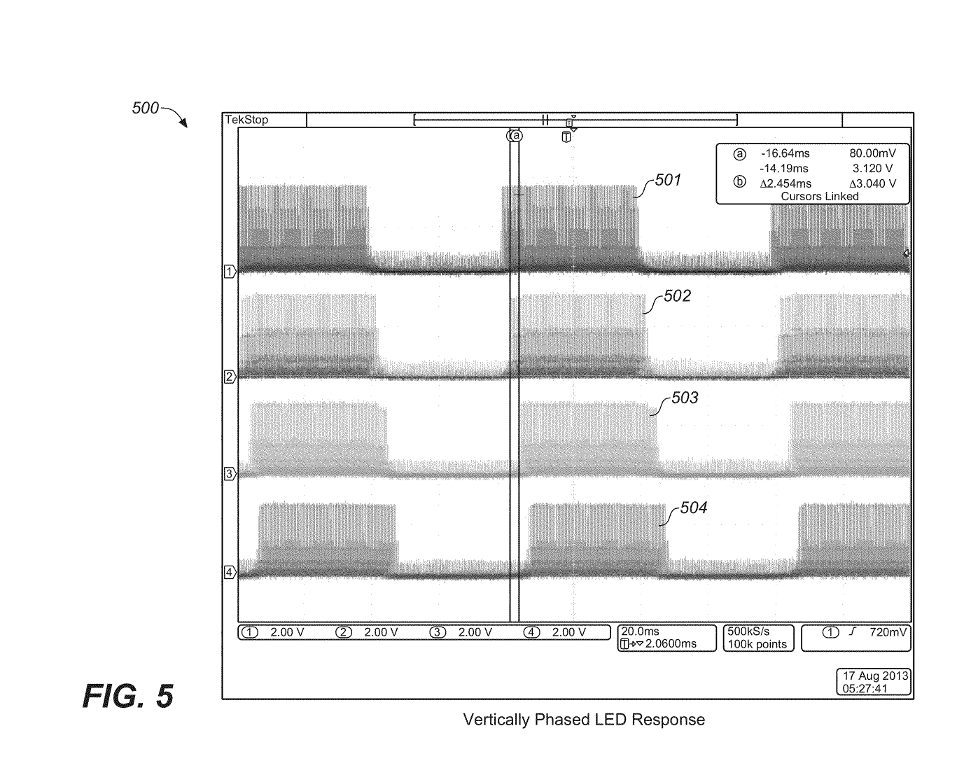

In the case of the LED backlight/LCD second modulator display systems, FIG. 5 depicts one embodiment of a technique that may tend to eliminate and/or mitigate any possible undesirable visual artifact. In this embodiment, it may be possible to phase the data/control signals to the LED array (as shown by signals 501, 502, 503, and 504).

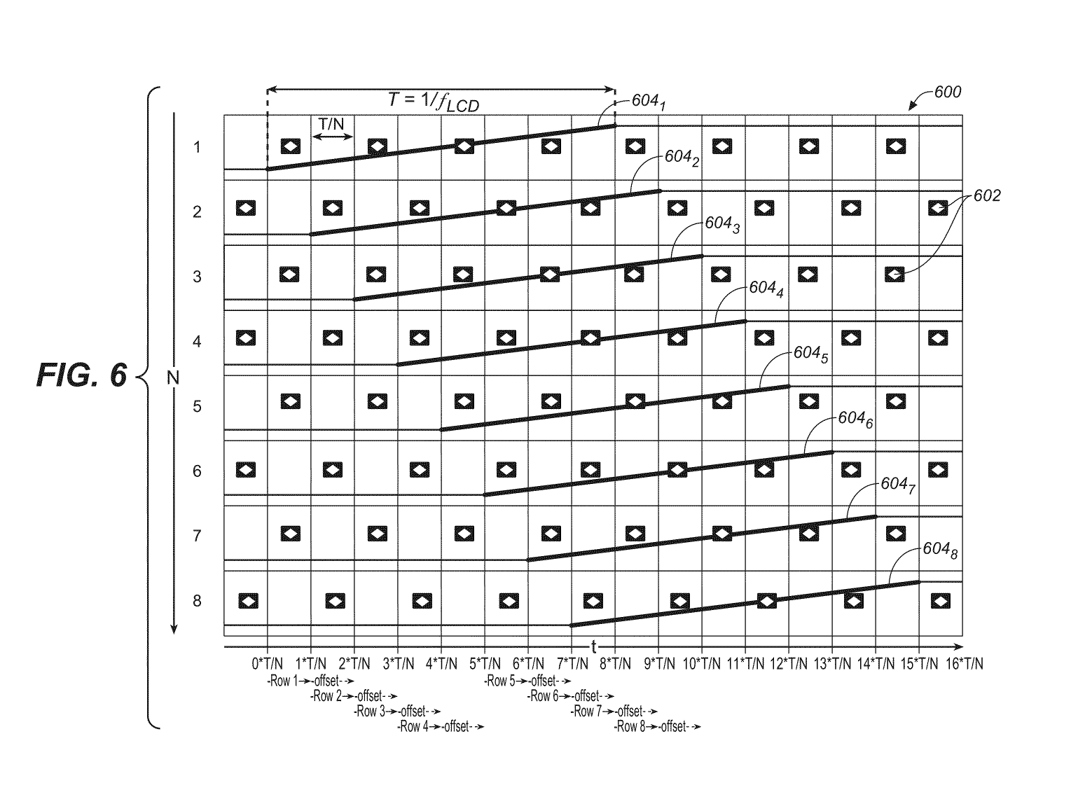

FIG. 6 is another depiction of the vertical phasing that may be applied to the LED backlight array 600. In order to mitigate the problem described, the backlight modulator may be updated with respect to the LCD. To achieve that, the backlight may be updated in a vertically phased manner—e.g., a row of backlight elements (LEDs) starts updating when the LCD region (that the LED is positioned in front of) is modified and so forth while moving down along the raster. By operating in this mode, a temporal synchronization between the two modulators may be achieved and the front of screen result presents a uniform output. Although a flashing output might still be an outcome of this sole solution (i.e. without any other techniques being applied simultaneously), a uniform flashing across the LCD may be considerably less visually objectionable to flashing that varies in intensity spatially across the LCD.

In the example of FIG. 6, the entire LCD transitions from a lower code-word to a higher code-word are represented by the bolded slope lines, 604₁ through 604₈. As may be seen, the lower the LCD region of the screen, the later it starts its transition. The horizontal time axis is divided into T/N portions, where N=8 in this case and

$$T = \frac{1}{{f}_{LCD}} .$$

Each vertical region starts transitioning approximately T/N seconds after the region above it.

Underneath the time axis, one embodiment of a suitable timing scheme is given which is essentially a description of when to transition a backlight row in order to achieve synchronization with the LCD.

In another embodiment, it may be desirable to apply an offset parameter to this timing scheme that may be derived offline, as is further described below.

Embodiments Employing Offline Analysis for Improved Offset

While there may be improvement with the mitigation of visual artifacts by applying the vertical phasing to the faster modulator as described above, there are other embodiments that may be applied that may tend to further improve the situation. In these embodiments, a time offset between the two modulator's (e.g. LED and LCD) start of transition time may be selected in a way that may further minimizes visual artifacts.

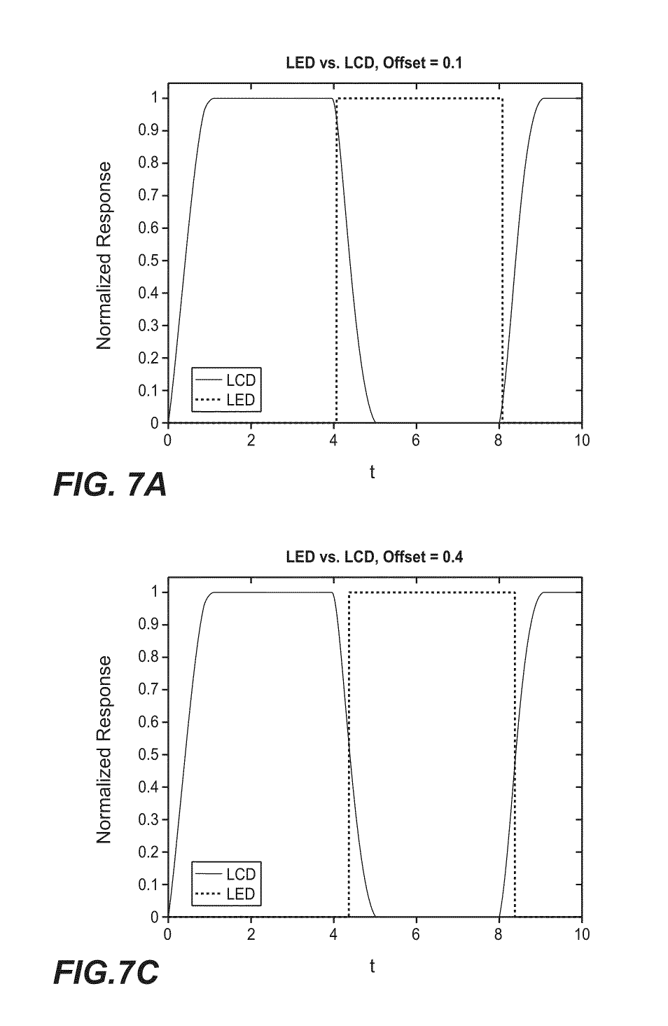

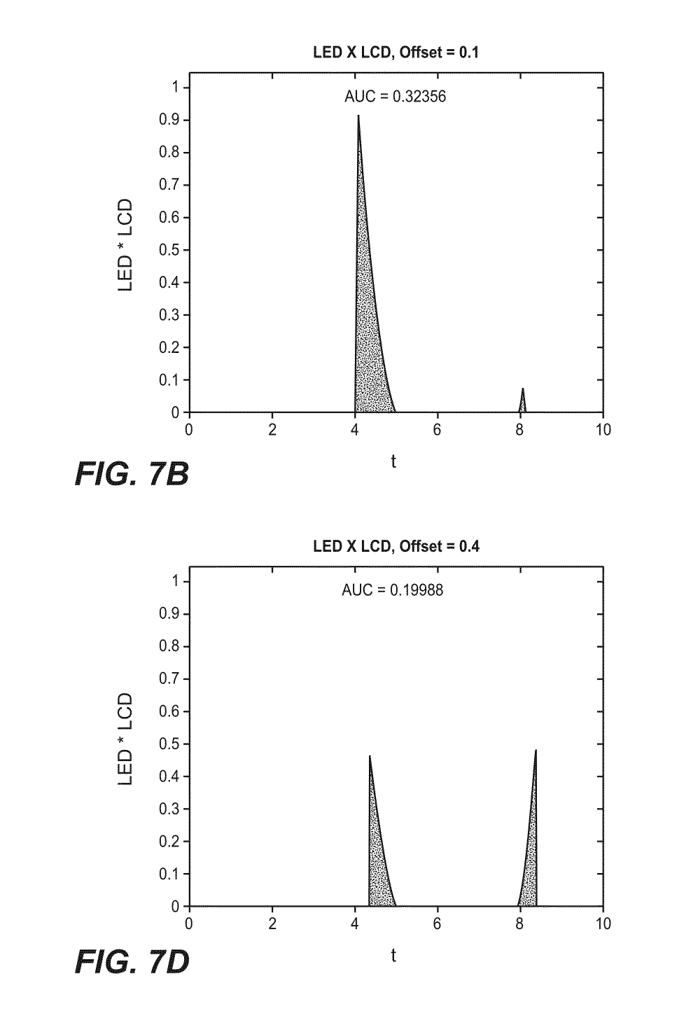

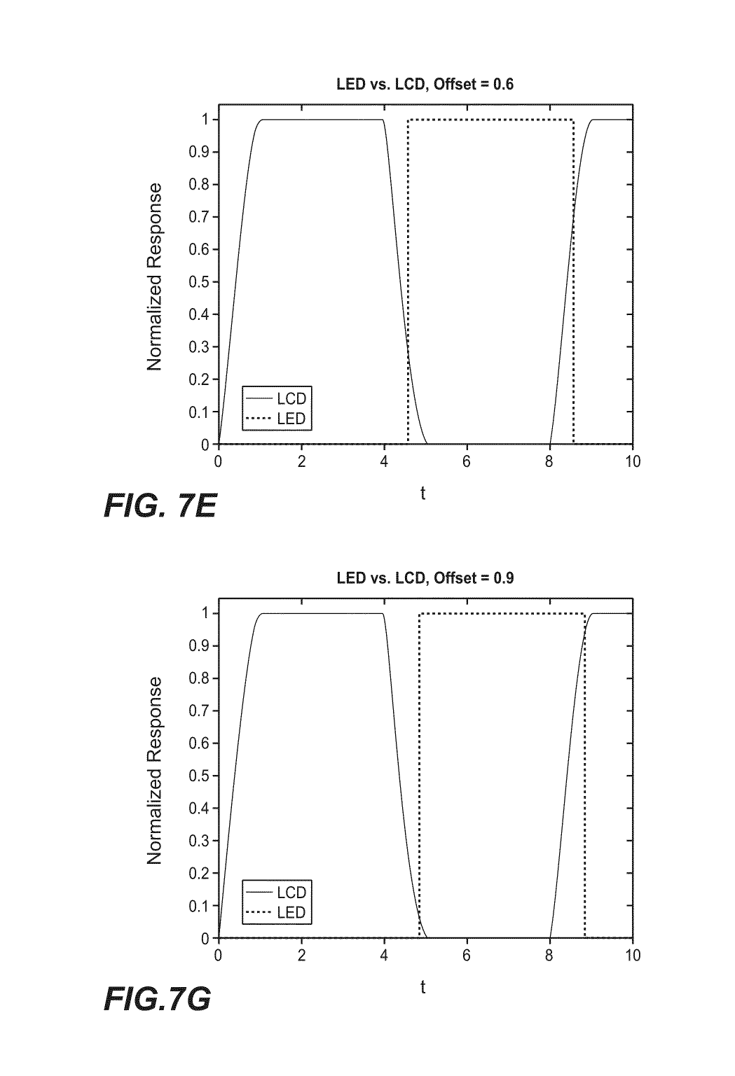

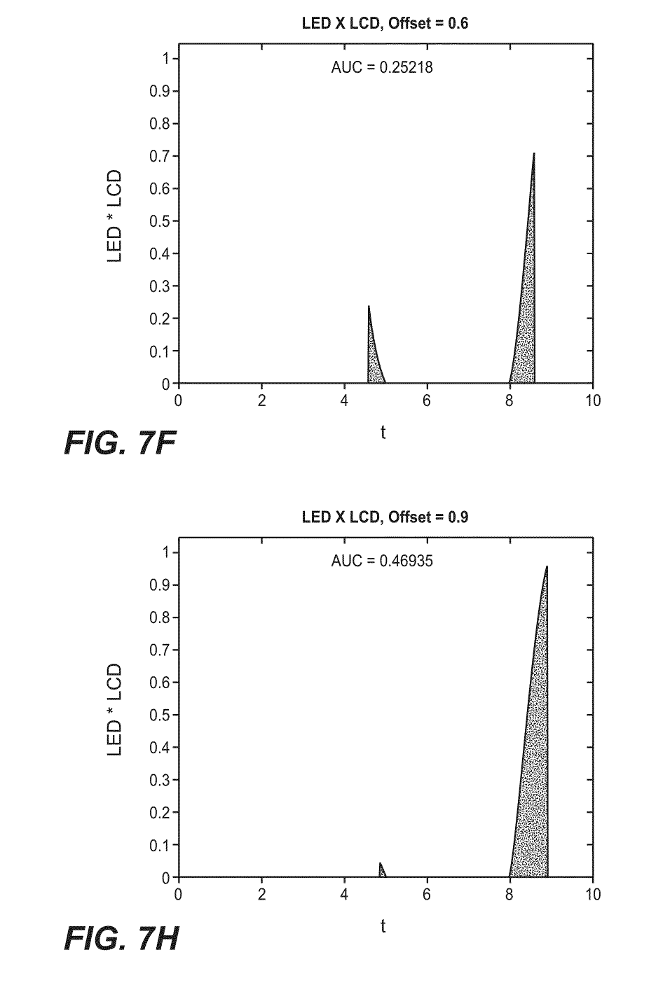

In one embodiment, an offline processing of the slow modulator's (e.g. LCD) characteristics may be discerned and applied. For example, in the case of an LCD, a LCD response may be used to synthesize a LCD output signal as shown in FIGS. 7A through 7H. The LCD's response is determined according to various offsets (e.g., offsets=0.1, 0.4, 0.6 and 0.9 in FIGS. 7A, C, E and G, respectively). It will be appreciated that other offsets may be used and suitable for purposes of the present application. As may also be seen, a putative LED response may be applied to these offset LCD response, as also shown in FIGS. 7A, C, E and G. In this case, the LED response is synthesized as substantially a simple step function—which is realistic in comparison to the LCD's time constants.

The integral of the multiplication (LCD×LED) is the observed light in front of screen. In this example, the LED and LCD are switching in opposite directions and in an ideal system the output light will remain constant. However, due to the different temporal behavior of the responses an excess light (flash) may result. It may be desirable to minimize this excess light by finding the optimal offset setting. It will be appreciated that the offline processing may also determine the excess light when the LEDs and the LCD are switching in the same direction and the scope of the present application encompasses such same directional switching. However, it was noted in repeated runs that switching in the opposite direction may be preferred.

FIGS. 7B, D, F and H depict the results of four arbitrary offset settings shown in FIGS. 7A, C, E and G (which show the LED and LCD responses overlaid on top of each other). FIGS. 7B, D, F and H are the Area Under Curve (AUC) plots that are achieved by integrating the multiplication of the LED & LCD responses. In general, large AUC results may be perceived as a visual flash to the human eye.

As may be seen, the offset setting tends to have a discernable effect on the AUC result. In this exemplary set of plots, it may be seen that the AUC is minimized when the AUC shape is of two balanced lobes such as with offset 0.4, as depicted in FIG. 7C. While different minimizing offsets may applied to different LCDs and LED and their combinations, such offsets may be computed and/or otherwise discerned—e.g., in an offline process. Such an offline process may input LCD (or the slower modulator's) characteristics that may be measured, calculated or otherwise derived, and may be input into such processing.

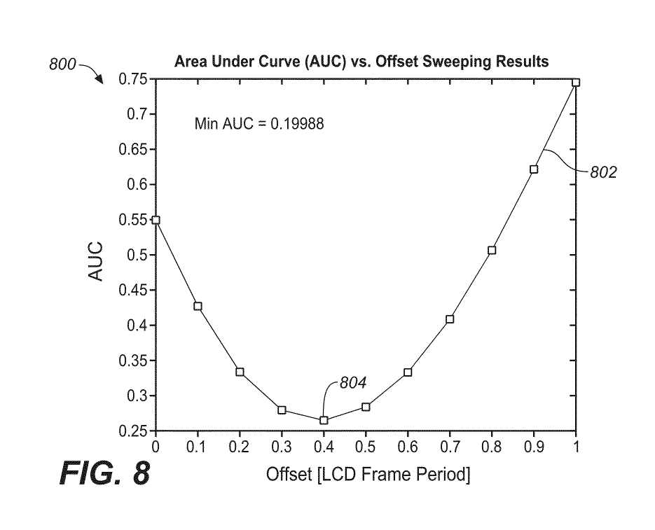

FIG. 8 depicts the AUC plot versus offset—showing that, in this example, an offset of 0.4 T, where T is an LCD frame period, yields the minimum AUC. These results of this offline analysis may be fed into a real time application of synchronizing the LED & LCD.

Embodiments Employing LED Slewing

Yet another system/method/technique for improving the visual experience may arise from the occasional image processing situations. For example, in a dual modulation display, the change in the source video signal may cause the two modulators to transition in opposite direction. For merely one example, abrupt appearance of text (e.g., subtitles) on the screen may cause the overall light field of the backlight behind it to increase. In order for other regions of the screen that did not change to maintain to same output, the LCD will have to ramp down (e.g., close) such that the combined (dual modulated) output is substantially maintaining the same luminance level as prior to the appearance of the text. This represents yet another opportunity to create undesired visual artifacts.

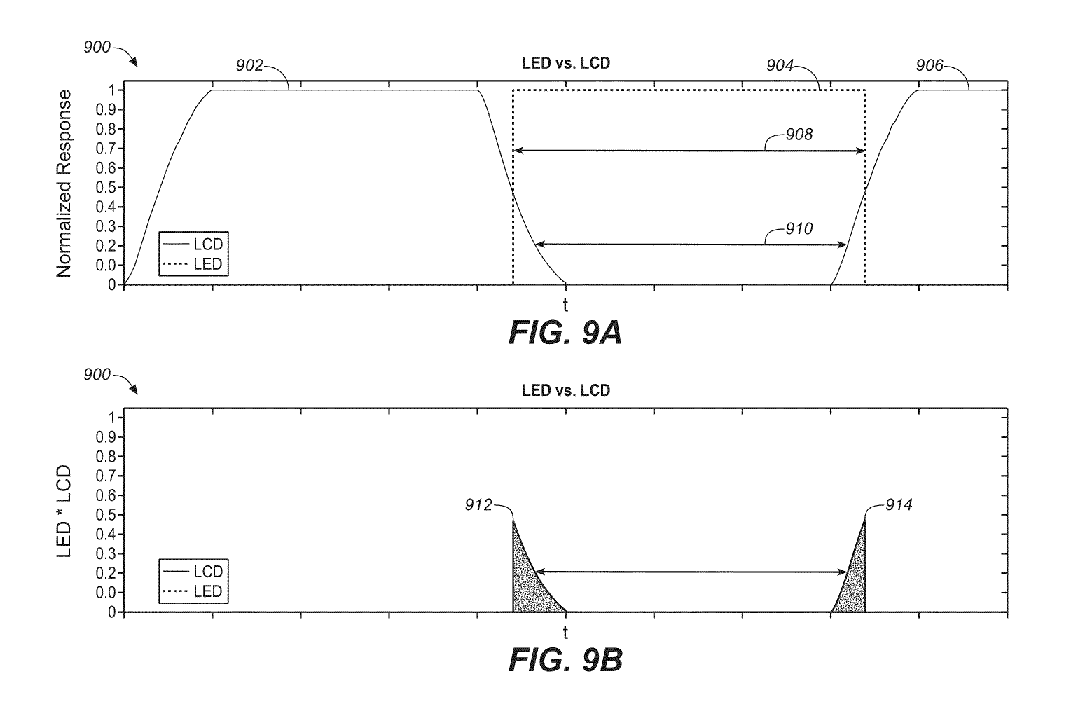

FIGS. 9A and 9B depict this situation 900 in which the LED/LCD are transitioning in opposite directions. As may be seen, LCD transitions 910 (between steady states 902 and 906) are slow when compared to nearly instantaneous LED transitions 908. The excess light is seen at 912 and 914 in FIG. 9B and may be characterized as: L=∫ₜ_{₁}^{t}^{₂}LED(t)*LCD(t)dt.

In addition, the following should also be noted:
(1) Individual LED transitions are substantially instantaneous (compared to the LCD transition period), so it is well represented with a step function;
(2) The LCD pixel response time is roughly an LCD cycle period (for example, for a 100 Hz refresh rate LCD which is approximately 10 ms);
(3) Although the LCD period is ˜10 ms, the source video input does not change as rapidly. In this example the input frame changes every 40 ms, equivalent to input video source of 25 Hz; and
(4) Due to the slow transition of the LCD, the multiplication will not be zero (as would be the case of an ideal system), and so the integral's result will be greater than 0. That would create excess light in front of screen, usually perceived as a short flash during the transition period.

LED Slewing

As with other techniques, this proposed solution is to minimize the amount of excess light during the opposite LED vs. LCD transitions. This is achieved by changing the shape of the signal driving the LED backlight. In one embodiment, as the amount of displayed light is the product of the LED and the LCD transmittance, the LED response would be an inverse of the LCD response, resulting in a constant amount of light (e.g., the product of the LED output and LCD transmittance) displayed throughout the LCD transition to its final transmittance.

LCD Characterization (Offline Analysis)

Similar to the discussion above, it may be desirable to determine the characteristics of a typical LCD—as well as the characteristics of dual modulation systems. Generally, LCD transition curves differ in shape as a function of the starting and ending transmittances, as well as the direction of the change (towards higher or lower transmittance). For generality then, it may be assumed that every pair of starting and ending transmittance values follows a unique curve.

If either end point transmittance level is fully open or closed, the slope of the inverse response (ideally realized by the LED) can be prohibitively steep and does not represent a good candidate for an LED response curve.

Mid-level to mid-level transmittance changes may be typically somewhat similar in shape (“mid-level” may be defined substantially as the 20% to 80% transmittance range). The most commonly encountered and objectionable flicker artifacts may occur in mid-level luminance areas that have bright objects coming or going nearby. For typical dual modulation systems, this often results in mid-level to mid-level LCD transmittance transitions. Therefore, the transitions that typically result in the most significant visual artifacts may behave somewhat similarly.

For dual modulation systems, hundreds or thousands of LCD elements are lit by the same LED and are likely to have unique transition curves as each experiences a slightly different backlight and may have a different target level (image pixel level). Each LED may have only one slew response between states, which affects each of the hundreds or thousands of pixels in the same way. One embodiment may attempt to minimize the most objectionable artifacts. In such an embodiment, this may mean targeting mid-level to mid-level transitions.

With suitable signal processing, an ‘average’ mid-level to mid-level transition curve may be created. Since this curve represents what has been identified as the potential solution for visible artifacts and does not look at any individual LCD elements, it can be applied without knowledge of the LCD element transitions. This represents a potential simplification in a real time algorithm—as the volume of LCD data may not need to be examined, and no real time decisions may be needed to be made to determine the ‘optimal’ solution.

LED Based on Inverse LCD (Offline Analysis)

With a reduced set of curves consisting of mid-level to mid-level transitions, it may be possible to find a representative curve that may improve most situations. From a group of mid-level transition curves experimentally collected (or calculated or otherwise derived), a level of precision may be desired in aligning the curves, thus, potentially avoiding noise at either endpoint and allowing a true average curve to be formed. This alignment and averaging may be used to create an inverse process to generate the LED slewing.

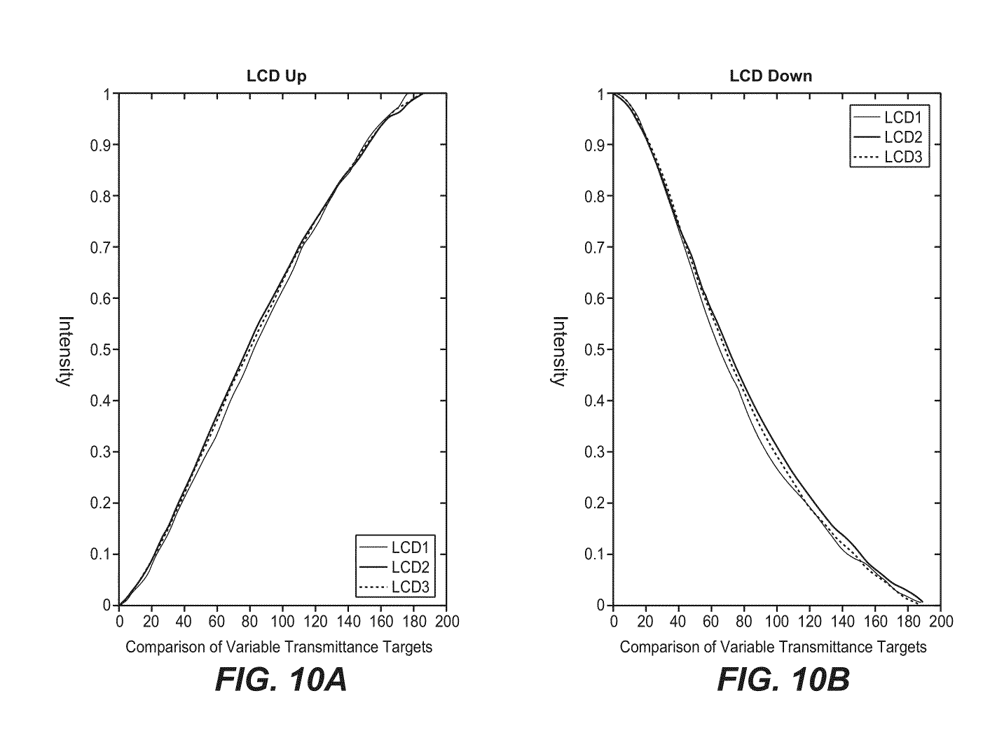

FIGS. 10A and 10B show increasing and decreasing LCD transmittance curves, respectively, for three different displays, each with different mid-level target transmittance ranges. These graphs show that for carefully selected ranges which are known to be among the most artifact inducing (mid-gray to mid-gray), similar curves are followed and this commonality may be exploited.

The curve generated from the fitting/averaging process of the greatly reduced set of transition curves represents an improved overall LED-LCD product regardless of the actual LCD transitions. It also represents the largest improvement possible by targeting the most common and most artifact inducing LCD transitions.

LED Slewing with LED/LCD Offset Embodiments

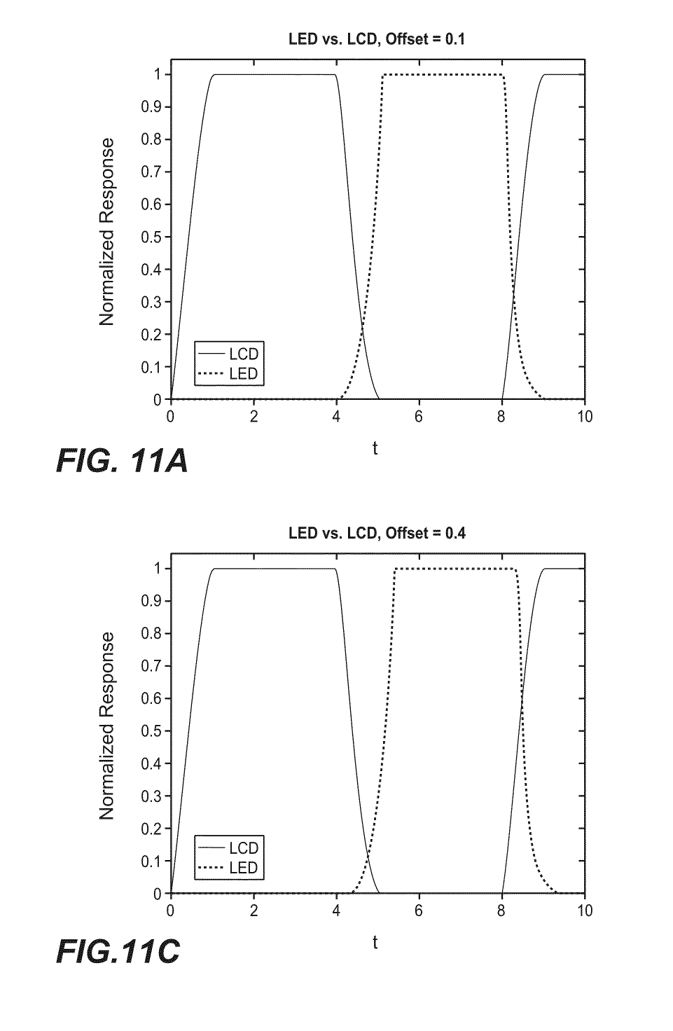

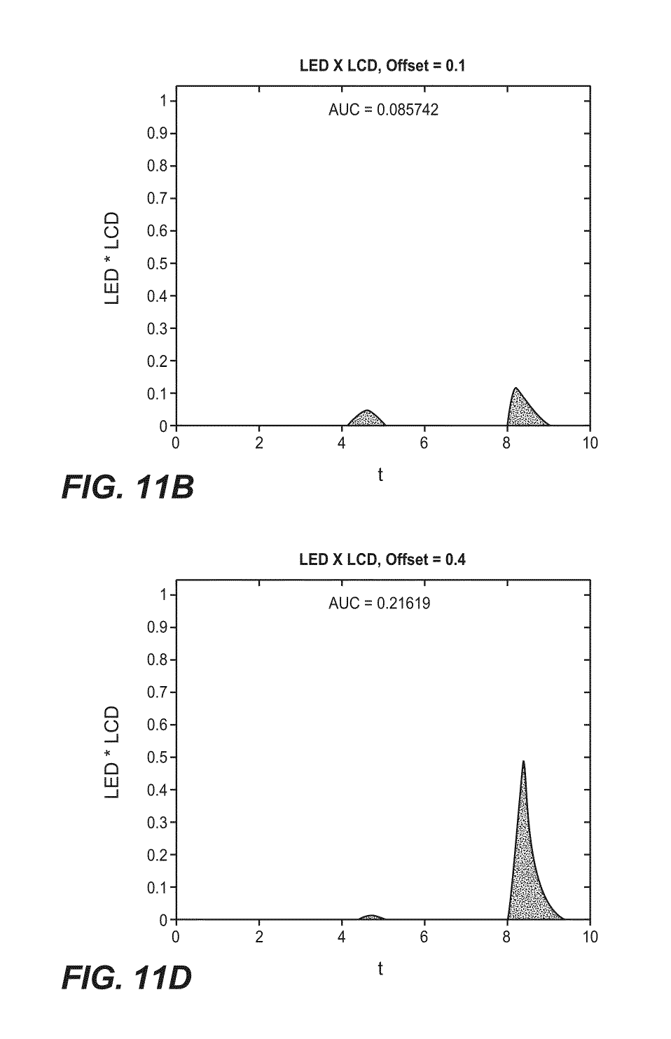

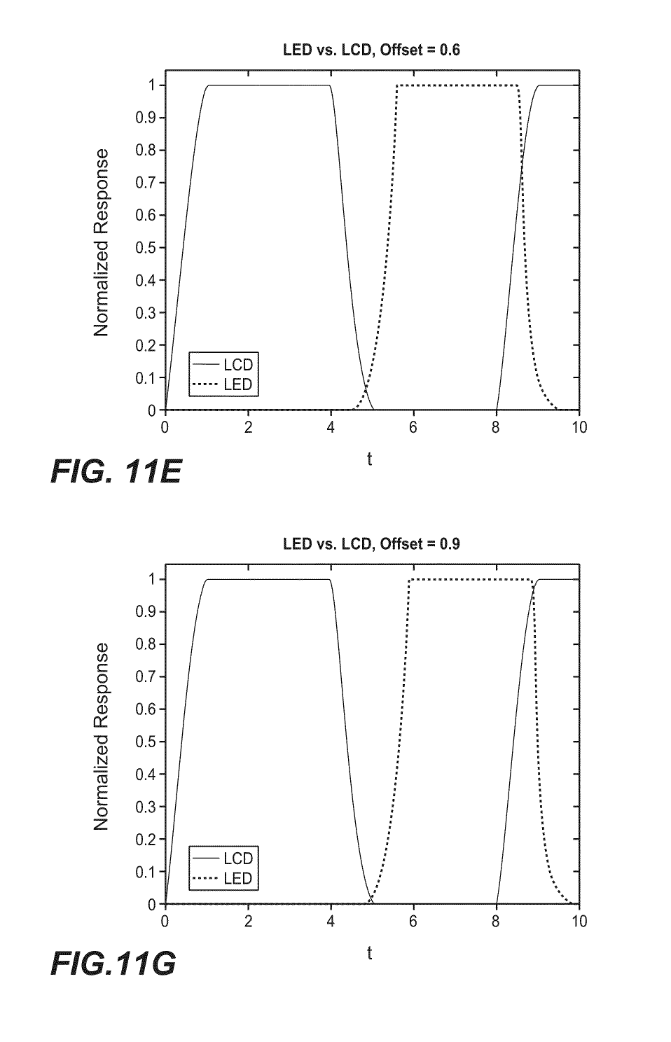

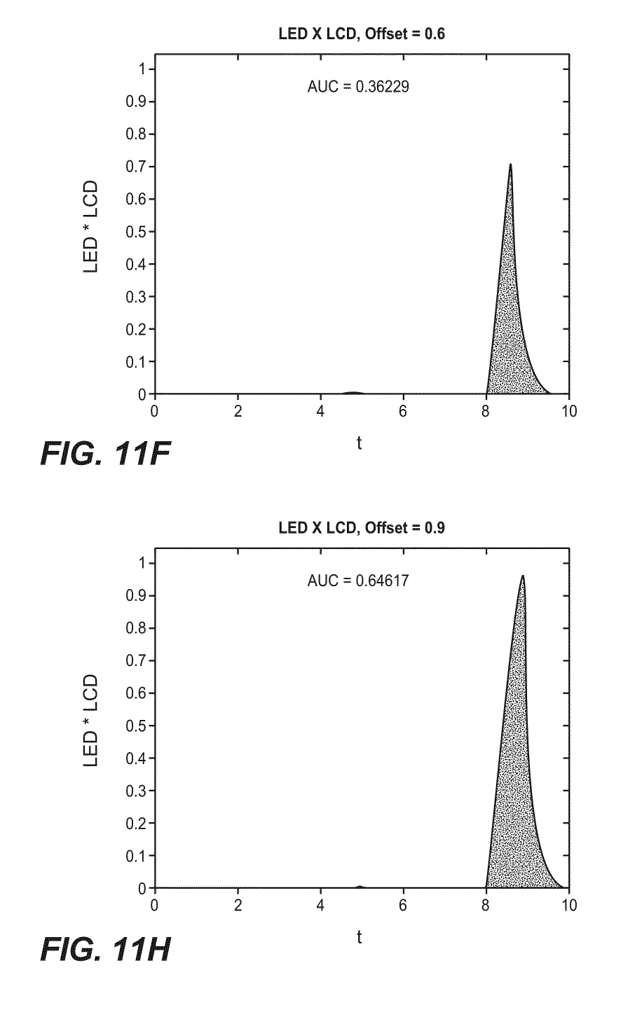

FIGS. 11A through 11H depict embodiments that combine LED slewing with offsets for good results for eliminating and/or mitigating undesired visual artifacts. As like in the discussion above, FIGS. 11A, C, E and G depict the application of four arbitrary offset settings—e.g., the LED response is shifted with respect to the LCD response. It will also be noticed that the LED control waveform exhibits suitable slewing (e.g. step-wise transitions, as opposed to nearly instantaneous ON/OFF transitions).

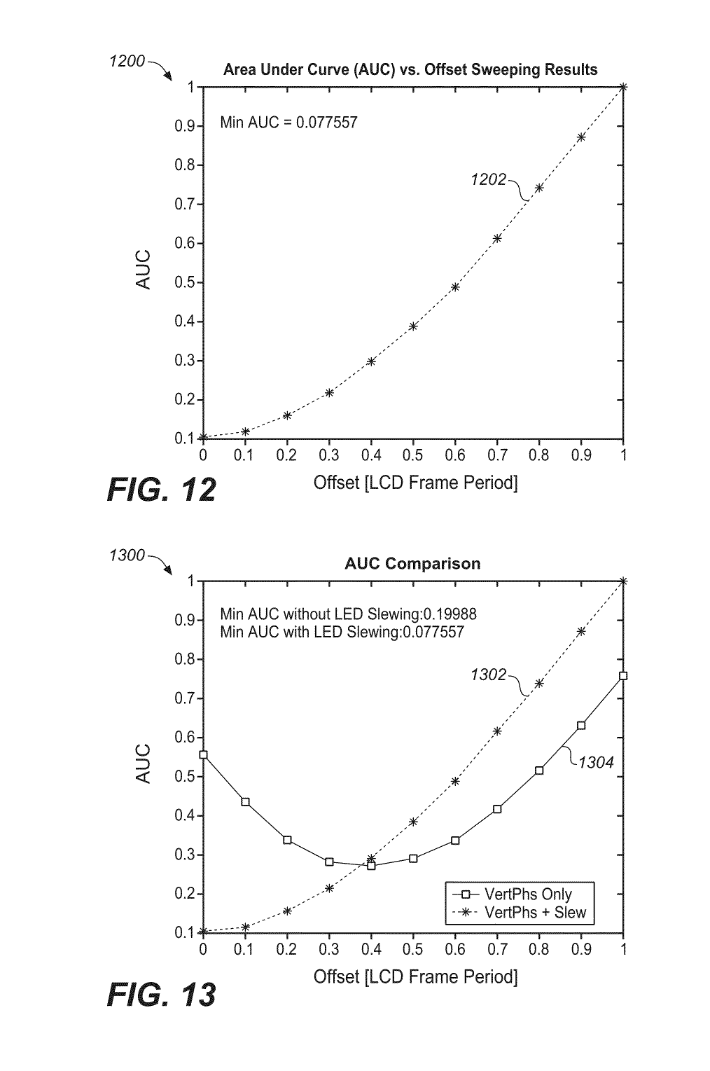

FIGS. 11B, D, F and H depict the Area under Curve (AUC) that is achieved by integrating the multiplication of the LED & LCD responses. A large enough AUC result may be perceived as a visual flash to the human eye. As similar to above, it may be observed that the offset setting has a noticeable effect on the AUC result. For this example, it may be noticed that the AUC is minimized when the AUC shape is of two balanced lobes such as with offset 0.1 in this example. FIG. 12 depicts the Area under Curve (AUC) vs. Offset sweeping results as curve 1202.

Real Time LED Slewing Embodiments

In one embodiment, these techniques described herein may be those that present a desired LED response that is derived from the LCD characteristics. This may be achieved in a system that is constructed to meet this goal. For example, if a DAC (digital to analog converter) was driving each individual backlight element, such a system may be possible; if not costly to realize.

In other embodiments, there may be systems where backlight elements are driven in a typical PWM (pulse width modulation) and other methods and techniques may be used. For example, a new LED response can be realized based on approximating the optimal LED response with a step function. The number of steps depends of the specifics of a given system's limitations. In general, the more steps that can be realized, the better the results will be.

Embodiments Combining LED Phasing & LED Slewing

In the previous discussion above, at least two problems and their relevant solutions were detailed. It may be possible to create many other embodiments by combining the various techniques described herein.

For one example, it may be possible (and possibly desirable) to combine the techniques of vertical phasing, LED slewing and/or offsetting to realize even further improvement in visual quality. FIG. 13 depicts the results comparing the effects of vertical phasing (1304) and vertical phasing plus LED slewing (1302). It may be seen that vertical phasing plus slewing provides better results than vertical phasing alone.

One Possible Embodiment

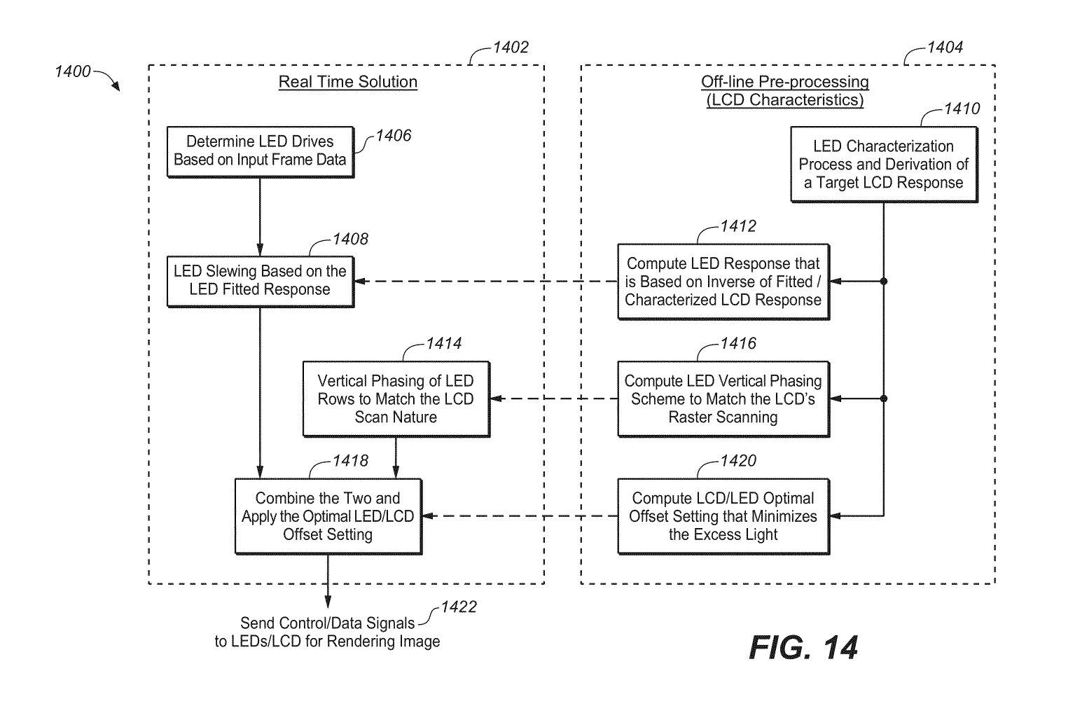

FIG. 14 is one flowchart embodiment (1400) that combines one or more of the techniques described herein. One aspect of this embodiment is that it is possible to take advantage of offline analysis of at least one of the modulators (e.g. the LCD) in order to characterize its behavior. Such characterization, as has been discussed, allows the system to improve visual quality. Although it may be possible to derive this modulator's characterization in real time (and the scope of the present application fully encompasses it), offline processing is also possible.

Having said that, in this embodiment, system/method 1400, the processing may therefore be parsed between real time processing 1402 and offline processing 1404. The controller of the display system may be suitable to process the real time processing (or some other controller, such as on a set top box, codec, or the like). The controller may receive input image data to render upon the display system and then determine the LED backlight values based upon the input image data at 1406. From offline processing 1404, the LCD may be characterized and potential responses to input image data may be derived at 1410.

At 1412, the LED response to the particular input image at issue may be derived, estimated or otherwise computed—e.g., as an inverse response to the LCD characterization and/or fitted to the input image data. This LED response may be an input into 1408 to determine the control/data signals to send to the LED backlight to effect LED slewing.

In addition to that, the system/method may compute the LED vertical phasing scheme to match the LCD's raster scanning at 1416. This may be input into 1414 to determine the control/data signals to send the LED rows to match the LCD scanning. The results of the control/data signals so derived and/or calculated may be combined at 1418—together with any possible offset computed at 1420 to send out a final control/data signal to the LEDs at 1422 in order to improve the visual quality and experience of the rendered images.

It should be appreciated that many other possible systems/methods that perform any one of the techniques, either singly or in combination, to affect different embodiments of such an improved dual/multi modulator display system. In addition, the results of the offline processing may be stored in computer readable memory residing in the display system (e.g., on a LUT, ROM, RAM or the like) and accessed by the display system in real time.

In one embodiment, the invention comprises a controller for a display system configured to receive image data. The data may be received, for example, over a computer network, Internet, private network (e.g., Virtual Private Network), from storage (e.g., optical disk, flash drive, hard drive, cloud based storage, or other storage systems), via or incorporating direct communications such as wireless, cell, Wi-Fi, Bluetooth, Near Field Communications (NFC) said image data to be rendered by the display system. In one embodiment, the image data is received from a user's account in a copyright controlled storage system such as Ultraviolet. The controller may be further configured to receive modulator characterization data based upon modulator behavior(s). The controller is, for example, embedded in the display system, and may be, for example, a mobile device, LED backlit LCD display, or a projector utilizing first and second modulation systems (e.g., dual LCD projection system). The projector may be a cinema projector that includes a DMD modulator that controls an illumination of a second modulator in a manner that incorporates one or both of vertical synching and slewing and/or matching any other characteristic of the second modulator. Such illumination control may be implemented via control of individual pixels of the DMD or groups of pixels forming tiles that are energized together (e.g., energized in predetermined patterns). Regardless of the mechanism for providing the illumination, the end result is an illumination that matches or corresponds to the characteristics of the second (downstream) modulator.

In one embodiment, the characteristics matching the vertical synching and slewing are either hardwired or programmed into the controller. In another embodiment, the characteristics of the second modulator are downloaded and stored in memory accessible to the controller and used by the controller to produce corresponding control signals. In one embodiment, a projector according to the present invention may be upgraded or repaired by the installation of a new second modulator and the characteristics of the new modulator are downloaded and installed in the controller accessible memory. The characteristics stored in the controller may be updated or modified based on recent updates or changes due to aging of one or both of the modulators. All of the above applies to projector, mobile device, computer monitor, and home entertainment type displays regardless of the types of modulators utilized in the displays.

In one embodiment, the backlight of a display is an OLED or other lighting system that exhibits measureable performance changes over its lifetime. The invention includes monitoring backlight performance and changing the particulars of how the backlight performs or maintains vertical synching and/or slewing based on the changes in backlight performance. The vertical synching and/or slewing may be changed according to measured changes in performance or may be made via programming on a predetermined time and/or usage schedule. In cases where aging issues are not known when the display is put into use (or even if they are), those aging issues may be addressed via an update to an energization algorithm that controls the backlight and does so in the context of the second modulator's known characteristics. Such updates may be linked to a user's content account, such as Ultraviolet, along with other display related data such as extended dynamic range or color gamut tables that may be generic to the user's display device or tailored for specific images or content.

In the above embodiments, the controller is configured to derive control signals from the image data for the backlight (e.g., LEDs, OLEDs, Laser light sources, combination of Laser light sources and modulator such as DMD, LCD, MEMS based modulators, etc.), the backlight control signals configured to provide a fitted response (illumination) based upon one or more behaviors (e.g., characteristics of an LCD or other modulator that are programmed into the controller, or based on data or programming such as data and/or programming downloaded to the controller). Ultimately, the backlight control signals are intended to be communicated to a backlight which is energized accordingly and producing the fitted response.

The controller is further configured to prepare and communicate 2nd modulator control signals to a second modulator illuminated by the backlight and configured to form the desired screen image.

A display system according to the invention may comprise a modulated light source, a second modulator illuminated by the modulated light source, and a controller that controls the modulated light source according to a combination of desired image data and characteristics of the second modulator. The characteristics may include for example, any characteristic related to performance or energization of the second modulator, or any combination of characteristics. The characteristics may include, for example, any combination of vertical synching and slewing of the second modulator or patterns of synching and/or slewing produced by the modulated light source that illuminate the second modulator.

A detailed description of one or more embodiments of the invention, read along with accompanying figures, that illustrate the principles of the invention has now been given. It is to be appreciated that the invention is described in connection with such embodiments, but the invention is not limited to any embodiment. The scope of the invention is limited only by the claims and the invention encompasses numerous alternatives, modifications and equivalents. Numerous specific details have been set forth in this description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A display system, said display system comprising:
a light source, said light source comprising an array of LED backlights;
an LCD modulator, said LCD modulator illuminated by said light source and modulating said light source to render an image;
a controller, said controller further comprising:
a processor;
a memory, said memory associated with said processor and said memory further comprising processor-readable instructions, such that when said processor reads the processor-readable instructions, causes the processor to perform the following instructions:
receiving image data, said image data to be rendered by said display system;
receiving LCD characterization data, said LCD characterization data based upon a characterization of the one or more LCD behaviors;
deriving LED control signals, said LED control signals providing a fitted LED response based upon one or more LCD behaviors; and
sending LED control signals to said light source and control signals to said LCD to form the desired screen image.

2. The display system of claim 1 wherein said LCD characterization data comprises one of a group, said group comprising: vertical phasing data, response curves and offset response data.

3. The display system of claim 2 wherein said LCD characterization data is computed in an offline procedure.

4. The display system of claim 2 wherein said LED control signals comprise signals that are adjusted to match the vertical phasing of the LCD modulator.

5. The display system of claim 2 wherein said LED control signals comprise signals that are slewed based upon the characterized LCD response.

6. The display system of claim 2 wherein said LED control signals comprise signals that are adjusted to match the vertical phasing of the LCD modulator and slewed based upon the characterized LCD response.

7. The display system of claim 4, wherein said LED control signals are offset with respect to the LCD response to minimize light area under the curve during frame transitions.

8. The display system of claim 5, wherein said LED control signals are offset with respect to the LCD response to minimize light area under the curve during frame transitions.

9. The display system of claim 6, wherein said LED control signals are offset with respect to the LCD response to minimize light area under the curve during frame transitions.

10. A method for providing LED signals to match LCD characteristics, said method comprising:
receiving input image data to be rendered on a display system, said display system further comprising an array of LED backlights illuminating an LCD modulator;
receiving data characterizing the raster scanning of the LCD;
calculating timing offsets to be applied to control signals to LEDs in proximity to the LCD pixels such that the LED illumination matches the raster scanning of LCD; and
sending the LED control signals to the LEDs.

11. The method of claim 10 wherein said method further comprises:
deriving the slewing to be applied to the LED control signals, said slewing based upon an fitted response of the LCD to the input image data.

12. The method of claim 11 wherein said method further comprises:
deriving an offset timing of the LED control signals with respect to the LCD control signals such that the light area under the curve is substantially minimized during frame transitions.

13. A display system, said display system comprising:
a light source;
a first modulator, said first modulator capable of modulating the light of said light source;
a second modulator, said second modulator capable of modulating the light from said first modulator, and wherein the response time of the faster modulator as between said first and second modulator is substantially faster than the other modulator;
a controller, said controller further comprising:
a processor;
a memory, said memory associated with said processor and said memory further comprising processor-readable instructions, such that when said processor reads the processor-readable instructions, causes the processor to perform the following instructions:
receiving image data, said image data to be rendered by said display system;
receiving characterization data of the slower modulator as between said first and second modulator, said characterization data based upon a characterization of the one or more said slower modulator's behaviors;
deriving control signals for said faster modulator, said control signals providing a fitted response based upon one or more behaviors of said slower modulator; and
sending control signals to said faster modulator light source and control signals to said slower modulator to form the desired screen image.

14. The display system of claim 12 wherein said display system further comprises an LED backlight array as said faster modulator and a LCD modulator as said slower modulator.

15. The display system of claim 12 wherein said display system further comprises a projector system comprising an LCD modulator as said slower modulator and said MEMS array as said faster modulator.

16. A projector comprising:
a modulated lighting device configured to illuminate a modulator configured to further modulate the illuminating light for viewing projection; a controller configured to control the modulated lighting device and the modulator according to image data, and wherein the controller provides a control signal to the modulated lighting device according to said image data and a characterization of the modulator such that a pattern in which the illumination is provided accounts for both properties of an architectural relationship between the lighting device and the modulator and the characterization of the modulator.

17. The projector according to claim 16, wherein the modulated lighting device comprises a plurality of different color laser light sources and at least one Digital Mirror Device (DMD).

18. The projector according to claim 16, wherein the characterization comprises at least one of vertical synching and slewing.

19. The projector according to claim 16, wherein the architectural relationship between the lighting device and the modulator comprises a correspondence between individually addressable elements such as lighting elements or pixels of the modulated lighting device and individually addressable elements of the modulator.

20. The projector according to claim 19, wherein the modulated lighting device comprises a plurality of different color laser light sources and at least one Digital Mirror Device (DMD), the characterization comprises at least one of vertical synching and slewing, and the architectural relationship comprises a many-to-one relationship between individually addressable elements of the modulated light source and pixels of the modulated lighting device, and a one-to-many relationship between pixels of the modulated light source and pixels of the modulator.
